(19) United States
(12) Patent Application Publication
(10) Pub. No.: US 2026/0018356 A1
(43) Pub. Date: Jan. 15, 2026

(54) MAGNETICALLY ATTACHABLE ELECTROMAGNETIC SWITCH AND ARMATURE PLATE CAPABLE OF INCREASING A DISCONNECTION SPEED

(71) Applicant: SONG CHUAN PRECISION CO., LTD., NEW TAIPEI CITY (TW)

(72) Inventor: SUNG-JEN WU, NEW TAIPEI CITY (TW)

(21) Appl. No.: 18/769,445

(22) Filed: Jul. 11, 2024

(51) Int. Cl. H01H 50/54; H01H 9/44; H01H 50/64

(52) U.S. Cl. CPC H01H 50/546; H01H 9/443; H01H 50/642

(57) ABSTRACT

A magnetically attachable electromagnetic switch includes: a coil assembly, a bracket assembly, a magnetic pole assembly, and a fixed contact assembly. The coil assembly has an induction coil and an iron core. The bracket assembly has a fixed plate on the coil assembly to form an extension end and an elastic part on the fixed plate. The magnetic pole assembly has an armature plate and a contact conduction part fixed to the armature plate and having at least one movable contact. The armature plate is pivoted to the extension end and fixed to the elastic part, situated at an ON position when in an electrically disconnected status, and situated at an OFF position when in an electrically connected status. The fixed contact assembly has a base and at least one fixed contact on the base. The armature plate includes at least one demagnetization opening.

### BACKGROUND OF THE DISCLOSURE

### Technical Field

The present disclosure relates to electromagnetic switches in general, and more particularly relates to a magnetically attachable electromagnetic switch and armature plate capable of effectively increasing the disconnection speed, and they are applied to electrical devices such as storage devices to meet the limitation criteria for their disconnection in order to maintain operational stability.

### Description of the Related Art

In general, the operation of electromagnetic switches is based on the use of the magnetic force generated by the inductive coil before and after the supply of power to drive the movable and fixed contacts on the switch to form an electrical disconnection or connection to control an electrical ON status. In addition, although the operation of an electromagnetic switch driven by electrical conduction is only a momentary action in terms of physical sensation, in terms of the actual operation of the equipment, too long an “operating time” or “disconnection time” may still result in inappropriate impacts on the operation of the equipment, where the so-called “operating time” is defined as the time consumed after the power is supplied until the movable and fixed contacts on the switch make contact with each other and the electrical state becomes conductive; and the “disconnection time” is defined as the time consumed after the power is turned off and the movable and fixed contacts on the switch are restored to their disconnected status of the electrical non-conducting state. Logically, the device can be driven to operate only when the switch is in the electrically connected status. Therefore, it is common to consider how to quickly drive the operation of equipment to meet the urgent situation or work efficiency requirements. In practice, it is usually focused on how to speed up the switch to form an electrical conduction state of the contact after power is turned on, that is on how to make improvements and reduce the “working time”.

However, for some special applications such as energy storage and charging devices, the importance of reducing the “disconnection time” is no less important than reducing the “working time”, for example, the “disconnection time” of the electromagnetic switch for high safety requirements is reduced to the time consumption of less than 5 milliseconds or even less than 2 milliseconds. Theoretically, the operating stroke of moving the movable contact to the fixed contact of the electromagnetic switch is usually considered as an operation completed after two reaction forces have been overcome at the aspect of action forces. These two reaction forces refer to “the elastic part reaction force” that occurs when the electromagnetic switch uses the elastic part to keep the movable contact in a normally open state; and “the contact reaction force” that occurs when the movable contact initially contacts the fixed contact. Therefore, in order to expedite the disconnection between the contacts, it is intuitively necessary to increase the aforementioned “elastic part reaction force” and “contact reaction force”. Once this is used as an entry point, the magnetic flux suction must be increased at the same time after the power supply to overcome the two reaction forces in order to maintain the normal stroke of the switch operation, so that it naturally has to increase the power supply to improve the output power of the coil, and this approach will consume unnecessary power consumption, which is an appropriate implementation method.

In view of the problems above, the team of the present disclosure has considered the related art technology and has not seen theories or better solutions for reducing the “disconnection time”, and therefore developed an electromagnetic switch structure that can maintain the original level of the “working time of the electromagnetic switch without increasing the power supply, while reducing the “disconnection time”.

### SUMMARY OF THE DISCLOSURE

It is a primary objective of the present disclosure to overcome the problems of the related art by providing an electromagnetic switch that maintains the operation of normally driving the disconnection and connection of the movable contact and the fixed contact before and after power supply and at the same time to reduce the “disconnection time” significantly.

To achieve the aforementioned objective, the present disclosure discloses a magnetically attachable electromagnetic switch with increased disconnection speed, which includes: a coil assembly, having an induction coil, and an iron core arranged in the axial direction of the induction coil; a bracket assembly, having a fixed plate and an elastic part, wherein at least one side of the fixed plate is arranged on the coil assembly and has a section beyond the coil assembly to form an extension end; the elastic part is arranged on the fixed plate and an end of the elastic part is fixed to the fixed plate; a magnetic pole assembly, having an armature plate and a contact conduction part, the contact conduction part being fixed to a side of the armature plate for a synchronous movement, the contact conduction part having at least one movable contact, an upper edge of the armature plate being pivoted to the extension end of the fixed plate and fixed to another end of the elastic part, and the armature plate being situated in an ON position under the pulling action of the elastic part when the coil assembly is in the electrically disconnected status, and when the coil assembly is situated at the electrically connected status, a magnetic force is generated to drive the armature plate to pivot towards the iron core so that the armature plate being situated in an OFF position, wherein an air gap spacing is defined between the armature plate and the iron core, and when the armature plate is at the ON position, the air gap spacing gradually increases from the upper edge of the armature plate to a lower edge of the armature plate; and a fixed contact assembly, having a base and at least one fixed contact disposed on the base, the base carrying the coil assembly, the fixed contact being configured to be corresponsive to the movable contact, and the movable contact contacting the fixed contact to define an electrically connected status when the armature plate is at the OFF position; wherein, the armature plate is provided with at least one demagnetization opening formed on an end side of the armature plate opposite a side where the armature plate and the fixed plate are pivoted to each other.

Preferably, the demagnetization opening shows a left-right symmetric hole shaped pattern based on a virtual mirror baseline defined by a middle position between a left end side and a right end side of the armature plate. For example, the demagnetization opening is in a strip-shaped hole pattern extending from the virtual mirror baseline to a left direction or a right direction of the armature plate; in a hat-shaped hole pattern with a brim slot and a crown slot formed after the left-right mirroring of the virtual mirror baseline; wherein the crown slot protrudes towards the upper edge of the armature plate. Preferably, the crown slot is an arc-shaped protrusion such that the demagnetization opening shows an Q-shaped hole pattern. Preferably, the demagnetization opening is formed by a plurality of parallel strip-shaped hole patterns, and the distance between the strip-shaped holes overlapped on the virtual mirror baseline and the lower edge of the armature plate is greater than the distance between other strip-shaped holes and the lower edge of the armature plate.

In summation, the magnetically attachable electromagnetic switch with increased disconnection speed in accordance with the present disclosure maintains the original disconnected and connected attaching strength of the electromagnetic switch under the same power supply level and maintains its normal operation through the special structural design of the armature plate. In other words, the configuration of forming the demagnetization opening at a specific position of the armature plate and the implementation mode of the corresponding openings destroys the magnetic path and range on the armature plate to expedite the demagnetization speed and reduce the “disconnection time” for various electrical devices such as storage devices that need to quickly reach a limit standard requirement of circuit breaking in order to effectively maintain the operational stability without substantially affecting the retention of attaching the electromagnetic switch.

### BRIEF DESCRIPTION OF THE DRAWINGS

FIG. 1 is a disassembled diagram of an electromagnetic switch in accordance with a preferred embodiment of the present disclosure;

FIG. 2 is an assembled diagram of an electromagnetic switch in accordance with a preferred embodiment of the present disclosure;

FIG. 3 is a schematic diagram of a armature plate with a demagnetization opening in accordance with a preferred embodiment of the present disclosure;

FIG. 4 is a schematic diagram showing a first implementation mode of a armature plate with a demagnetization opening in accordance with a preferred embodiment of the present disclosure;

FIG. 5 is a schematic diagram showing a second implementation mode of a armature plate with a demagnetization opening in accordance with a preferred embodiment of the present disclosure;

FIG. 6 is a schematic diagram showing a third implementation mode of a armature plate with a demagnetization opening in accordance with a preferred embodiment of the present disclosure; and

FIG. 7 is a schematic diagram showing a fourth implementation mode of a armature plate with a demagnetization opening in accordance with a preferred embodiment of the present disclosure.

### DETAILED DESCRIPTION OF THE PREFERRED EMBODIMENTS

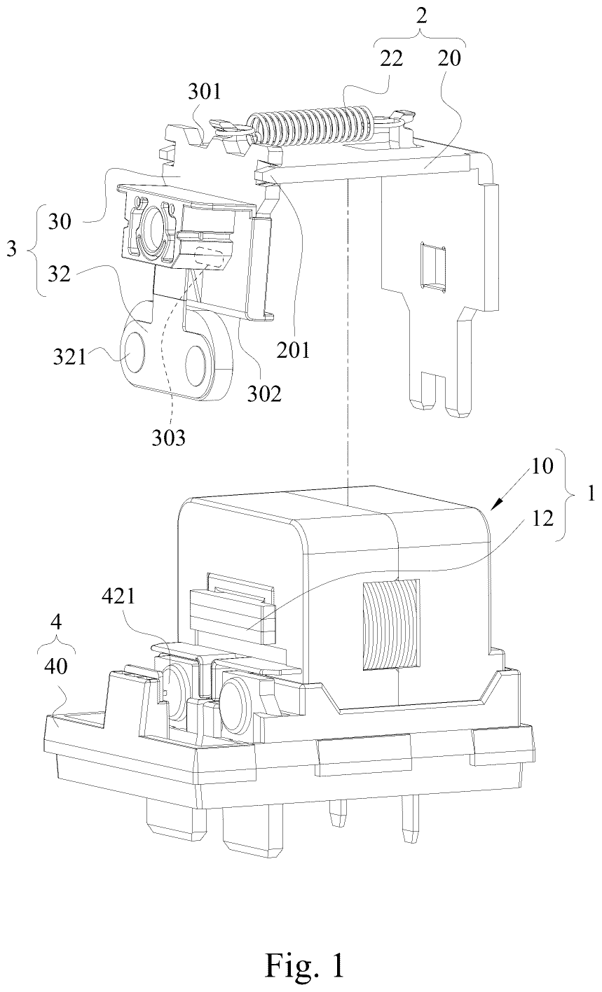

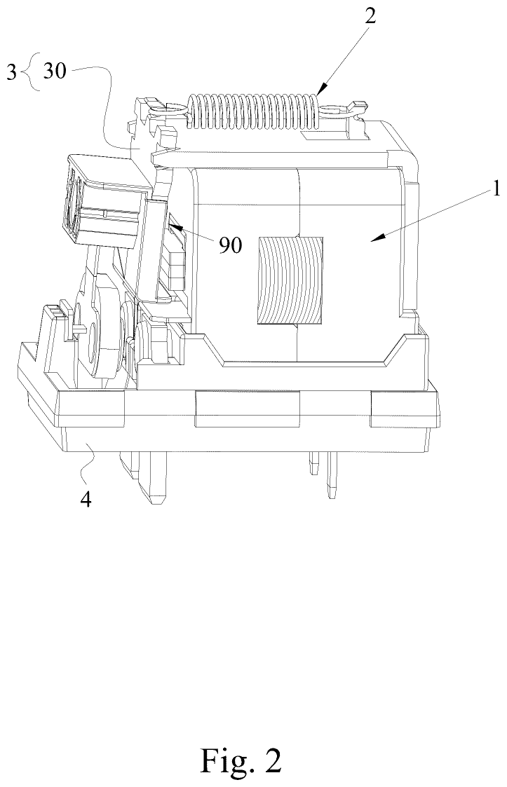

With reference to FIGS. 1 and 2 for the disassembled and assembled disconnection speed in accordance with a preferred embodiment of the present disclosure respectively, the magnetically attachable electromagnetic switch includes a coil assembly 1, a bracket assembly 2, a magnetic pole assembly 3, and a fixed contact assembly 4. The coil assembly 1 is mainly provided for generating a magnetic attaching force for the electromagnetic switch after the power is turned on, and it includes an induction coil 10 formed by winding and an iron core 12 arranged in an axial direction of the winding of the induction coil 10. In short, a magnetic circuit generated by the induction coil 10 and another metal conductor near the iron core 12 will form a continuous magnetic path by the magnetic force, at which time the metal conductor can be attracted and attached by the iron core 12.

The bracket assembly 2 includes a fixed plate 20 and an elastic part 22 such as a spring or spring plate, etc. and at least one side of the fixed plate 20 is arranged on the coil assembly 1 and having a section beyond the fixed plate 20 to form an extension end 201. In other words, the fixed plate 20 and the coil assembly 1 are not completely overlapped with each other; and the elastic part 22 is disposed on the fixed plate 20, and an end of the elastic part 22 is fixed to the fixed plate 20, for example, an end of the elastic part 22 can be fixed by another hook, ring, or similar structure extending from the fixed plate 20. The fixed plate 20 of the bracket assembly 2 can be bent to allow the iron core 12 to pass through in order to achieve the fixation effect.

Further, the magnetic pole assembly 3 is configured to be corresponsive to the bracket assembly 2, the magnetic pole assembly 3 includes an armature plate 30 and a contact conduction part 32, the armature plate 30 is driven by a magnetic force to move towards the iron core 12 after power is supplied to the coil assembly 1, and the contact conduction part 32 is fixed to a side of the armature plate 30, so that when the armature plate 30 is attracted by the magnetic force, the contact conduction part 32 will be move together synchronously. The contact conduction part 32 is provided with at least one movable contact 321, an upper edge 301 of the armature plate 30 is pivoted to the extension end 201 of the fixed plate 20 and fixed to another end of the elastic part 22, for example, grooves formed on the left and right ends of the armature plate 30 are provided for partially embedding the extension end 201 for a pivotal connection, and the elastic part 22 is fixed to the middle position of the upper edge 301 of the armature plate 30. In this way, when the armature plate 30 under the electrically disconnected status of the coil assembly 1 is only driven by the pulling force of the elastic part 22 and situated at an ON position; the magnetic attraction force generated under the electrically connected status of the coil assembly 1 overcomes the pulling force of the elastic part 22, so as to drive the armature plate 30 to pivotally rotate towards the iron core 12 and situate at an OFF position. Further, an air gap spacing 90 is formed between the armature plate 30 and the iron core 12. When the armature plate 30 is situated at the ON position, the distance of the air gap spacing 90 gradually increases from the upper edge 301 of the armature plate 30 to a lower edge 302 of the armature plate 30.

Further, the fixed contact assembly 4 includes a base 40 and at least one fixed contact 421 arranged on the base 40, the base 40 is provided for carrying the coil assembly 1, the fixed contact 421 is configured to be corresponsive to the movable contact 321, and when the armature plate 30 is situated at the OFF position, the movable contact 321 contacts with the fixed contact 421 to define an electrically connected status. Of course, the base 40 can be configured to be corresponsive to the coil assembly 1 and connected to the corresponding bracket assembly 2, the magnetic pole assembly 3 can be various kinds of grooves with specific shape, dimensions, rigidity and strength, or various modifications and adjustments such as boreholes. Since such modifications or adjustments do not limit or affect the fulfilment of the purpose of the present disclosure, and thus they will not be described in details here.

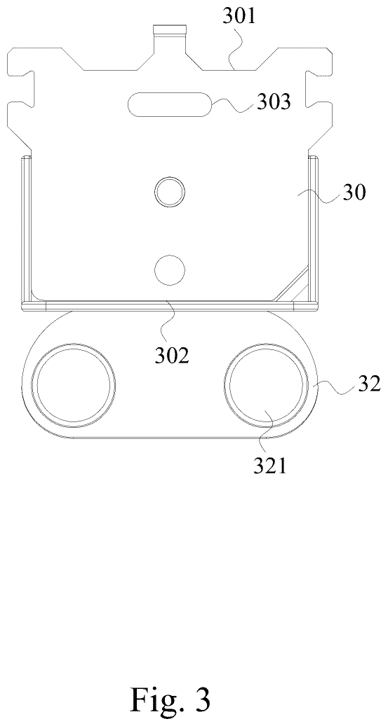

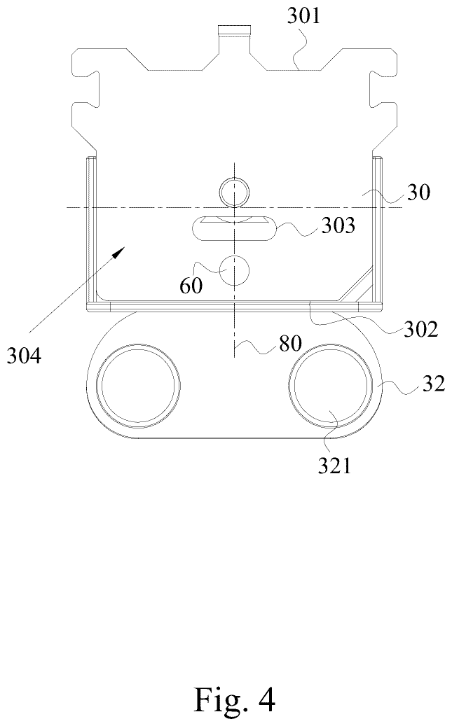

Further, considering that the magnetic attraction between the coil assembly 1 and the armature plate 30 is proportional to the cross-sectional area of the armature plate 30, that is, when the cross-sectional area of the armature plate 30 increases, the coverage of its magnetic path increases and the attraction force so created will be relatively larger. In view of this phenomenon, the present disclosure attempts to destroy the integrity of the magnetic path on the armature plate 30, causing the magnetic force distribution to be disconnected to affect the attraction strength, so as to achieve the effects of accelerating the demagnetization speed and reducing the “disconnection time”. With reference to FIG. 3 as well for the schematic diagram of a demagnetization opening of an armature plate in accordance with an experimental embodiment of the present disclosure, although the armature plate 30 of this embodiment includes at least one demagnetization opening, it is found that once the position of the demagnetization opening 303 shifts towards a side of the pivoting edge of the armature plate 30 and the fixed plate 20, the armature plate 30 is pivoted relative to the fixed plate 20 for a circumferential swing, so that when the armature plate 30 is situated at the ON position, the air gap spacing 90 gradually increases from the upper edge 301 of the armature plate 30 to a lower edge 302 of the armature plate 30. In addition, the size of the air gap spacing 90 is inversely proportional to the square of the magnetic attraction so created. In other words, when the distance of the air gap spacing 90 between the armature plate 30 and the iron core 12 is the maximum, the magnetic attraction is relatively very small, and vice versa. Therefore, when the demagnetization opening 303 is opened as shown in FIG. 3, the magnetic attraction will be greatly attenuated, thereby affecting the normal opening and closing operation of the iron plate 30 and the iron core 12. If the normal operation is to be maintained, the external power supply must be increased to improve the magnetic attraction. However, this approach is not what is intended in this case. Therefore, it is known from the experimental embodiment that in order not to affect the normal operation of the armature plate 30 and the iron core 12, but to destroy the integrity of the magnetic path through the demagnetization opening 303 and speed up the demagnetization time, the armature plate 30 of the present disclosure is still provided with the demagnetization opening 303, but the demagnetization opening 303 is situated on another end side relative to the pivoting edge of the armature plate 30 and the fixed plate 20 as shown in FIG. 4. Thus, the above configuration conditions of the demagnetization opening 303 can effectively achieve the quick demagnetization effect. In order to avoid the demagnetization opening 303 from being too close to the pivoting edge of the armature plate 30 and the fixed plate 20 and affecting the attraction force, the present disclosure further limit the demagnetization opening 303 to be situated in a clamping area 304 between another end side relative to the pivoting edge of the armature plate 30 and the fixed plate 20 at the OFF position and the mapping position of the iron core 12 corresponding to the armature plate 30, and the demagnetization opening 303 is in a strip-shaped hole pattern or a hat-shaped hole pattern.

Since the whole piece of the armature plate 30 swings and pivots relative to the iron core 12, in order to maintain the balance of its movement, it is necessary to take into account the symmetry of destroying the magnetic path for the configuration of the demagnetization opening 303, so as to avoid uneven magnetic attractions on the left and right sides of the armature plate 30, which will wear out or damage the switch swinging mechanism after a long time of use. Therefore, the demagnetization opening 303 presents a left-right symmetric hole shaped pattern based on the virtual mirror baseline 80 defined at the middle position between the left and right end sides of the armature plate 30 to prevent the above situation from happening. At the same time, in order to achieve the effect of affecting the demagnetization by the demagnetization opening 303 as much as possible, the width of the lower edge 302 of the armature plate 30 can be designed to be smaller than the width of the upper edge 301 of the armature plate 30. Therefore, the magnetic attraction between the iron plate 30 and the iron core 12 can be kept relatively large to maintain the normal operation of opening and closing the electromagnetic switch.

With reference to FIGS. 4 to 7 for the schematic diagrams showing the first to fourth implementation modes of the armature plate 30 with a demagnetization opening 303 in accordance with a preferred embodiment of the present disclosure respectively, to ensure the attaching position of the armature plate 30 and the iron core 12 after they get closed to each other, the armature plate 30 is provided with a bump 60 formed on the same side having the demagnetization opening 303 and the bump 60 is disposed on the virtual mirror baseline 80. Therefore, the configuration of the bump 60 can be used to ensure the attaching position and prevent sideway swing. Further, once the bump 60 is used for ensuring the attaching position, the impact of the position of the bump 60 must also be considered for destroying the integrity of the magnetic path. Accordingly, the approximate attaching range is ensured by the bump 60, and the shortest distance from the bump 60 to the lower edge 302 of the armature plate 30 is smaller than or equal to the shortest distance from the demagnetization opening 303 to the lower edge 302 of the armature plate 30. Therefore, the destruction of the magnetic path caused by the demagnetization opening 303 has the effect of substantially increasing the demagnetization rate and reducing the “disconnection time” by means of the above configuration conditions.

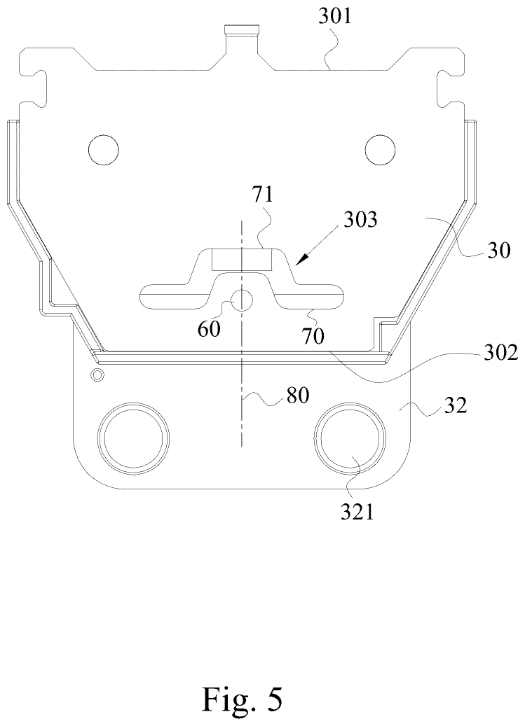

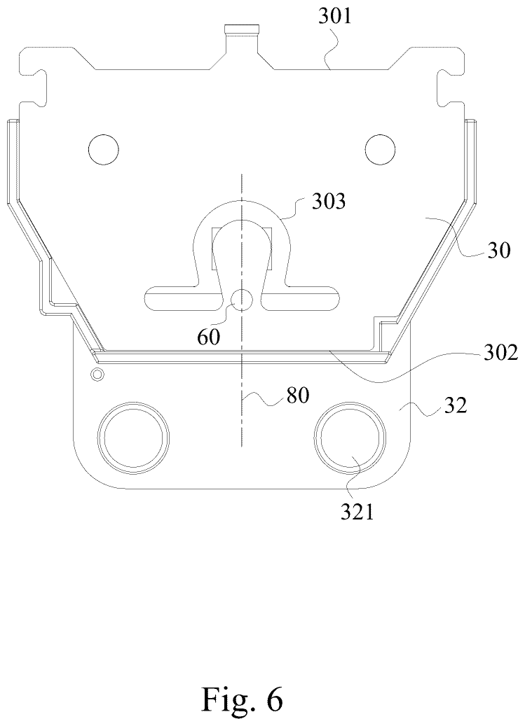

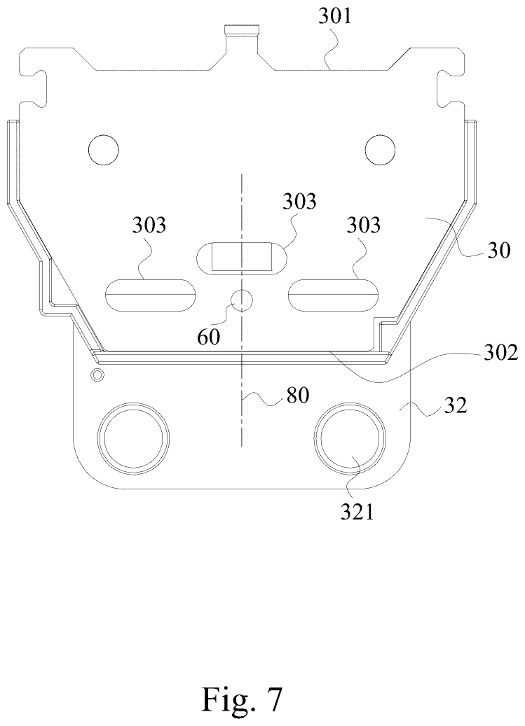

In FIG. 4, the demagnetization opening 303 is in a strip-shaped hole pattern extending from the virtual mirror baseline 80 in a left direction or a right direction towards the armature plate 30. In this way, the destroy of the integrity of the magnetic path speeds up the demagnetization speed and reduces the “disconnection time” and the process will not affect the attraction between the armature plate 30 and the iron core 12. In FIG. 5, the demagnetization opening 303 is in a hat-shaped hole pattern with a brim slot 70 and a crown slot 71 formed by the left-right mirroring of the virtual mirror baseline 80, and the crown slot 71 protrudes towards the upper edge 301 of the armature plate 30; or as shown in FIG. 6, the crown slot 71 is an arc-shaped protrusion, and the demagnetization opening shows an 2-shaped hole pattern. In FIG. 7, the demagnetization opening 303 is formed by a plurality of parallel strip-shaped hole patterns, and the distance from the overlapped strip-shaped hole of the virtual mirror baseline 80 to the lower edge 302 of the armature plate 30 is greater than the distance from other strip-shaped holes to the lower edge 302 of the armature plate 30. All the above demagnetization openings 303 should be configured on the lower edge 302 of the armature plate 30 and based on the virtual mirror baseline 80, they should be symmetrical openings. Where the bump 60 is designed, the limitation of the distance relative to the bump 60 and the lower edge 302 of the armature plate 30 must also be followed. In practice, various electrical equipment requirements, the size of the armature plate 30 and other factors must be observed, and the demagnetization opening 303 can be formed accordingly to achieve the desired “disconnection time” for destroying the magnetic path.

In summation, the armature plate 30 in the plurality of magnetically attachable electromagnetic switches has an end pivoted and driven by the magnetic force to swing after power is supplied. To achieve a quicker disconnection speed, the non-pivoted end of the armature plate 30 can be provided with one or more demagnetization openings 303, and the demagnetization opening 303 can be in a striped pattern or a hat-shaped hole pattern. Of course, the purpose of the central or symmetric configuration of the demagnetization opening 303 on the armature plate 30 is to improve the balance of swinging to improve the product life. Therefore, even with an asymmetrical or eccentric configuration, the quick disconnection effect can still be achieved.

In summation of the description above, the magnetically attachable electromagnetic switch of the present disclosure provides a special structural design of the armature plate, such that the original electromagnetic switch can still maintain its normal opening and closing operation and attraction strength under the same level of power supply. In other words, the special arrangement for the position of the armature plate and the configuration of the demagnetization opening and the corresponding holes, or the relative configuration conditions and relations of the demagnetization opening when the bump is designed, or the designed with of the armature plate, etc. can destroy the magnetic path on the armature plate, thereby accelerating the demagnetization speed and reducing the “disconnection time” without substantially affecting the retention force of the electromagnetic switch, so that various electrical devices such as storage devices and other similar devices that need to quickly reach the limit standard of circuit breaking requirements, can effectively maintain their operational stability.

What is claimed is:

1. A magnetically attachable electromagnetic switch capable of increasing a disconnection speed comprising:
a coil assembly having an induction coil, and an iron core installed along an axial direction of the induction coil;
a bracket assembly having a fixed plate and an elastic part, wherein at least one side of the fixed plate is provided on the coil assembly and the at least one side of the fixed plate has a section beyond the coil assembly to form an extension end, the elastic part is disposed on the fixed plate, and an end of the elastic part and the fixed plate are fixed to each other;
a magnetic pole assembly having an armature plate and a contact conduction part, the contact conduction part being fixed to a side of the armature plate for a synchronous movement, the contact conduction part having at least one movable contact, an upper edge of the armature plate being pivoted to the extension end of the fixed plate and being fixed to another end of the elastic part, such that the armature plate being situated in an ON position under a pulling action of the elastic part when the coil assembly is in an electrically disconnected status, and when the coil assembly is situated at an electrically connected status, a magnetic force is generated to drive the armature plate to pivot towards the iron core so that the armature plate being situated in an OFF position, wherein an air gap spacing is defined between the armature plate and the iron core, and when the armature plate is situated at the ON position, the air gap spacing gradually increases from the upper edge of the armature plate to a lower edge of the armature plate; and
a fixed contact assembly having a base and at least one fixed contact disposed on the base, the base carrying the coil assembly, the at least one fixed contact being configured to be corresponsive to the at least one movable contact, and the at least one movable contact contacting the at least one fixed contact to define the electrically connected status when the armature plate is situated at the OFF position,
wherein the armature plate is provided with at least one demagnetization opening formed on an end side of the armature plate opposite a side where the armature plate and the fixed plate are pivoted to each other.

2. The magnetically attachable electromagnetic switch according to claim 1, wherein the at least one demagnetization opening is situated in a clamping area between the end side of the armature plate and a position where the iron core is mapped to the armature plate when the armature plate is situated at the OFF position.

3. The magnetically attachable electromagnetic switch according to claim 1, wherein the at least one demagnetization opening is in a strip-shaped hole pattern.

4. The magnetically attachable electromagnetic switch according to claim 1, wherein the at least one demagnetization opening is in a hat-shaped hole pattern.

5. The magnetically attachable electromagnetic switch according to claim 1, wherein the at least one demagnetization opening is in a left-right symmetric hole shaped pattern based on a virtual mirror baseline defined by a middle position between a left end side and a right end side of the armature plate.

6. The magnetically attachable electromagnetic switch according to claim 5, wherein the at least one demagnetization opening is in a strip-shaped hole pattern extending from the virtual mirror baseline in a left direction or a right direction of the armature plate.

7. The magnetically attachable electromagnetic switch according to claim 5, wherein the at least one demagnetization opening is in a hat-shaped hole pattern with a brim slot and a crown slot formed after left-right mirroring from the virtual mirror baseline, and the crown slot protrudes towards the upper edge of the armature plate.

8. The magnetically attachable electromagnetic switch according to claim 7, wherein the crown slot is an arc-shaped protrusion, such that the at least one demagnetization opening is in an Q-shaped hole pattern.

9. The magnetically attachable electromagnetic switch according to claim 5, wherein the at least one demagnetization opening is formed by a plurality of parallel strip-shaped hole patterns, and a distance between a portion of a plurality of parallel strip-shaped holes overlapped on the virtual mirror baseline and the lower edge of the armature plate is greater than a distance between another portion of the plurality of parallel strip-shaped holes and the lower edge of the armature plate.

10. The magnetically attachable electromagnetic switch according to claim 1, wherein the armature plate further comprises a bump formed on the same side as the at least one demagnetization opening and disposed on the virtual mirror baseline, and a shortest distance from the bump to the lower edge of the armature plate is smaller than or equal to a shortest distance from the at least one demagnetization opening to the lower edge of the armature plate.

11. The magnetically attachable electromagnetic switch according to claim 10, wherein the lower edge of the armature plate has a width smaller than a width of the upper edge of the armature plate.

12. An armature plate for increasing a disconnection speed of a magnetically attachable electromagnetic switch, having an end pivoted and swung by a magnetic force before and after an electric connection, characterized in that a non-pivoted end of the armature plate is formed with at least one demagnetization opening.

13. The armature plate according to claim 12, wherein the at least one demagnetization opening is a strip-shaped hole.

14. The armature plate according to claim 12, wherein the at least one demagnetization opening is a hat-shaped hole.
